(19) United States
(12) Patent Application Publication
(10) Pub. No.: US 2020/0160189 A1
(43) Pub. Date: May 21, 2020

(54) System and Method of Discovering Causal Associations Between Events

(71) Applicant: International Business Machines Corporation, Armonk, NY (US)

(72) Inventors: Debarun Bhattacharjya, New York, NY (US); Owen Cornec, Yorktown Heights, NY (US); Tian Gao, Berkeley Heights, NY (US); Nicholas Mattei, White Plains, NY (US); Dharmashankar Subramanian, White Plains, NY (US)

(21) Appl. No.: 16/197,002

(22) Filed: Nov. 20, 2018

(51) Int. Cl. G06N 5/02; G06N 5/04; G06N 7/00; G06F 16/901; G06F 9/54

(52) U.S. Cl. CPC G06N 5/022; G06N 5/042; G06F 9/542; G06F 16/9024; G06N 7/00

(57) ABSTRACT

A method of discovering and presenting associations between events includes discovering causal association scores for pairs of events in an event dataset, and generating a sequence of events based on the causal association scores.

### BACKGROUND

The present invention relates generally to a method of discovering and presenting associations between events, and more particularly, a method of discovering a causal association between a pair of events using an event dataset, and generating a sequence of events based on the causal association scores.

Discovering causal relationships from observational data is widely studied in a variety of fields including statistics, artificial intelligence (AI) and machine learning (ML). Recent efforts to design systems that discover and use pairwise causal associations for downstream reasoning and processing include some who identify cause-effect pairs from news articles and make predictions about potential future events by generalizing the causal relationships. Others learn cause-effect pairs from text, representing these relationships in a graph.

Still others describe a scenario generation system based on a planning formulation. As input, they use expert-provided “mind maps” that capture causal connections among concepts.

Causal knowledge has also been assessed through crowd sourcing, such as in the open mind common sense project.

### SUMMARY

In an exemplary embodiment, the present invention includes a method of discovering a relationship between events. The method includes discovering causal association scores for pairs of events in an event dataset, and generating a sequence of events based on the causal association scores. One or more other exemplary embodiments include a computer program product and a system.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways that should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 illustrates a method 100 of discovering a causal association between events, according to an exemplary aspect of the present invention.

FIG. 2 illustrates a system 200 for discovering a causal association between events, according to an exemplary aspect of the present invention.

FIG. 3 depicts an example event dataset, according to an exemplary aspect of the present invention.

FIG. 4 illustrates Table 1 which shows the pairwise inter-rater probabilities, the mean over rater pairs and Fleiss' κ, according to an exemplary aspect of the present invention.

FIG. 5 illustrates Table 2 which shows the accuracy over folds (mean±standard deviation) corresponding to the best hyper-parameter configuration for each model and country, for the majority vote task, according to an exemplary aspect of the present invention.

FIG. 6A illustrates the accuracy across the folds for the majority vote task for Argentina, according to an exemplary aspect of the present invention.

FIG. 6B illustrates the accuracy across the folds for the majority vote task for Brazil, according to an exemplary aspect of the present invention.

FIG. 6C illustrates the accuracy across the folds for the majority vote task for Venezuela, according to an exemplary aspect of the present invention.

FIG. 7 illustrates Table 3 which presents best mean accuracy (over folds) for the majority vote task as a function of the actor-based conditions, according to an exemplary aspect of the present invention.

FIG. 8A illustrates the accuracy for the confidence strength task for Argentina, according to an exemplary aspect of the present invention.

FIG. 8B illustrates the accuracy for the confidence strength task for Brazil, according to an exemplary aspect of the present invention.

FIG. 8C illustrates the accuracy across for the confidence strength task for Venezuela, according to an exemplary aspect of the present invention.

FIG. 9A illustrates Table 8 which presents a causal association based sequence with duration in Brazil, according to an exemplary aspect of the present invention.

FIG. 9B illustrates Table 9 which presents a causal association based sequence of six events and their duration in Mexico, according to an exemplary aspect of the present invention.

FIG. 9C illustrates an exemplary embodiment of an interactive visualization tool 900 (e.g., a screenshot of a tool), according to an exemplary aspect of the present invention.

FIG. 10 depicts a cloud-computing node 10 according to an embodiment of the present invention;

FIG. 11 depicts a cloud-computing environment 50 according to an embodiment of the present invention; and

FIG. 12 depicts abstraction model layers according to an embodiment of the present invention.

### DETAILED DESCRIPTION

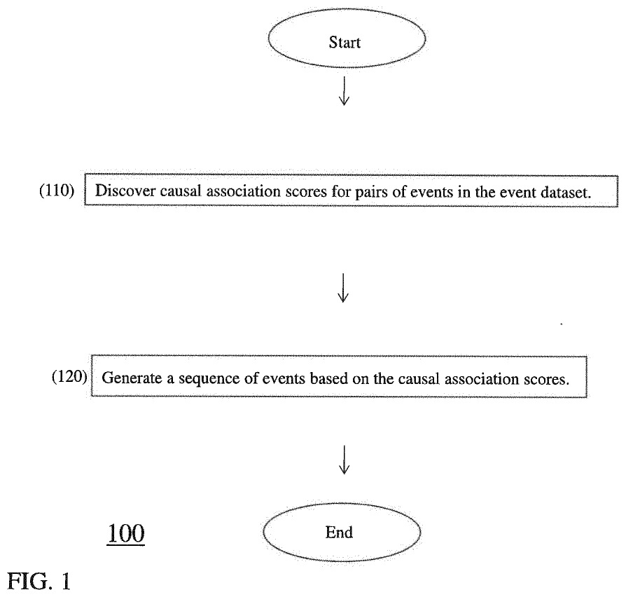

The invention will now be described with reference to FIGS. 1-12, in which like reference numerals refer to like parts throughout.

There has been substantial work around studying event datasets, spanning several analytical domains. In statistics, there is a long history of modeling such datasets as multivariate Poisson processes. In data mining, event datasets have been used for identifying patterns and making predictions about target events.

The literature has spilled over into the domains of artificial intelligence and machine learning, exploring sophisticated temporal processes including Poisson networks, continuous time noisy-or (CT-NOR) models, Poisson cascades, piecewise-constant conditional intensity models, and forest-based point processes, to name a few.

Some have proposed graphical event models (GEMs) as a generalization of the afore-mentioned multivariate temporal processes. They can be viewed through a causal modeling lens, much like causal networks can be seen as directed graphical models imbued with causal semantics. As discussed below, the present invention may discover conditional intensity based scores from a generative model that can be viewed as a special case of a GEM.

Despite the extensive literature on event datasets, most of the work on studying pairwise causal associations appears in natural language processing and computational linguistics, where events are textual phrases that are sometimes also associated with semantic information. Much of this literature revolves around the idea that “causes” change the probabilities of their “effects”. For a pair of events (y,x), y could potentially be a cause of effect x if x happens more frequently when y happens relative to its base rate, i.e. p(x|y)>p(x).

Although this approach identifies dependence between events, there are clearly caveats towards its usage for discovering causal relationships. For example, (y,x) could have a common cause z and still satisfy p(x|y)>p(x).

Despite its limitations, pairwise co-occurrence has been popular in causal discovery from text since others proposed the use of mutual information for word association, computed by identifying co-occurrence of words in a corpus. It is common for pairwise co-occurrence to be used in conjunction with the use of discourse cues to glean causal relationships. Discourse cues are linguistic patterns in the form of “A led to B”, “if A then B”, etc., which provide semantic knowledge about how phrases relate to each other.

Others have deployed these textual cues together with statistical co-occurrence based scores for discovering cause-effect pairs in text. In this way, they use association through co-occurrence for reinforcing evidence about causal relationships. As described below, the present invention may extend these scores to account for temporal order between events in event datasets.

An exemplary aspect of the present invention may discover (e.g., learn) a causal association between pairs of events, defined abstractly as “a particular thing that happens at a specific time and place, along with all necessary preconditions and unavoidable consequences”. In particular, the present invention may build a computational system that identifies potential causal associations using event datasets, i.e. data about occurrences of various type of events over a timeline. Such a system could provide data-driven support to analysts, assisting them with thoughtful and reasoned analysis about potential future states of the world.

Existing systems either rely on identifying cause-effect relations from unstructured text or through human-assessed representations or from joint observations of random variables. In contrast, an exemplary aspect of the present invention may investigate learning causal associations using structured event datasets as input. This complements other related research in AI as it provides another potential route for causal discovery from real-world data, and has numerous downstream applications.

Although the causal association scores discovered (e.g., learned) by the present invention may apply generally to any event dataset, a focus of the present invention is primarily on relational (also known as dyadic) event datasets in our empirical investigation, where events involve interaction between two actors, represented in the form Actor1→Action→Actor2. Note that the attention of the present invention is directed to association between pairs of events, as opposed to more complex structures, primarily due to the practical reason that it is significantly easier for analysts to understand pairwise associations rather than conditional causal relationships. Furthermore, it is important for the present invention to be scalable in both the number of types of events as well as the size of the event dataset.

The present invention makes many contributions over the related art methods. In particular, the present invention considers the task of discovering pairwise association in structured event datasets and proposes a suite of algorithms that generate scores used to discover causal relationships. In particular, the present invention introduces a novel framework that may incorporate all of the scores.

The present invention may further propose a continuous-time point process approach that uses the ratio of conditional intensity rate parameters from a graphical event representation. Described below is the manner in which these scores apply to relational event datasets such as the political event dataset ICEWS where it may be possible to enforce additional knowledge pertaining to actor identities. Further, the inventors have conducted an experiment in which they built an evaluation benchmark using human assessments and compare the performance of various scores on ICEWS event pairs, as described in detail below.

FIG. 1 illustrates a method 100 of discovering a causal association between events, according to an exemplary aspect of the present invention. The method 100 includes discovering (110) causal association scores for pairs of events in an event dataset, and generating (120) a sequence of events based on the causal association scores.

The method 100 may also include generating a graph based on the causal association scores, the graph displaying the sequence of events on a timeline, and inputting an inter-event time estimate for the pairs of events from a related model.

The graph may enable interactive analysis by a user such that the user can study the graph and conduct local discovery around an event. In particular, the graph may display the generated sequence of events as an event narrative which is displayed as a time-stamped walk in a digraph having event types represented by nodes, a cause-effect relationship from predecessor to successor represented by a directed edge, a causal association score represented by a weight of the directed edge, and an inter-event duration represented by a time-stamp on the nodes.

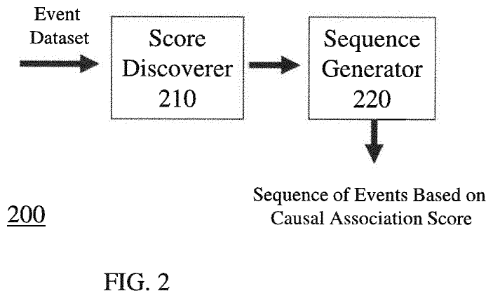

FIG. 2 illustrates a system 200 for discovering a causal association between events, according to an exemplary aspect of the present invention. The system 200 includes a score discoverer 210 for discovering causal association scores for pairs of events in an event dataset, and sequence generator 220 for generating a sequence of events based on the causal association scores.

An event dataset is a sequence of events,D={Dᵢ}ᵢ₌₁^{N}. Each event Dᵢ is a tuple (xᵢ, tᵢ) where xᵢ is the event label/type and tᵢ is the time of occurrence, tᵢ∈R⁺. The present invention may assume a strictly temporally ordered dataset, tᵢ<tⱼ for i<j, initial time t₀=0 and end time t_{N+1}=T. The term y,x refers to an arbitrary pair of event types belonging to label set L.

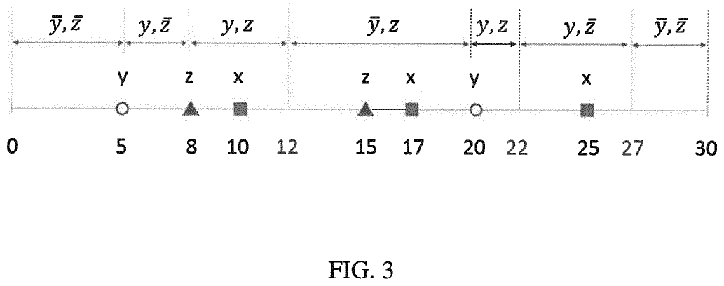

FIG. 3 depicts an example event dataset, according to an exemplary aspect of the present invention. In particular, FIG. 3 illustrates an example event dataset with 7 occurrences of 3 types of events (i.e., x, y and z) over a month (30 days). Duration partitions for various conditions of labels y and z for a window of 7 days are also highlighted.

Below is described a general framework for computing causal association scores from an event dataset, such as that in FIG. 3. To illustrate the generality and practicability of this framework, a description will be provided for computing causal association scores from computational linguistics that are purely data-driven, based only on temporal co-occurrence. Then, description will be provided for discovering causal association scores based on generative models with conditional intensity rates of events.

A popular approach to causal modeling is based on independence tests. However, high-dimensional tests can be intractable in general causal relationships. To discover causal event pairs, the present invention may adopt the same paradigm and consider the following framework of hypothesis testing:

H₀: P(x|y,Z)=P(x|Z);

H₁: P(x|y,Z)≠P(x|Z), (1)

where (y,x) is the pair to be tested and Z is a set of other event labels. The null hypothesis tests if P(x|y,Z) and P(x|Z) are from the same distribution, which indicates y has no impact on x and hence cannot be a cause for x. The probabilities can be modeled with different methods and the independence tests can use different metrics, but the general form to be evaluated is f (P(x|y,Z), P(x|Z)). This general framework is used below when discussing the proposed causal association scores.

Scores based on temporal co-occurrence either implicitly or explicitly use some combination of necessity and sufficiency to determine causality. A pair (y,x) has high necessity causality when p(y|x) is high. That is, the cause is likely to have occurred if the effect is observed, e.g., (rainfall, flooding). A pair has high sufficiency causality when p(x|y) is high. That is, x is a likely effect given the cause, e.g., (storm, damage).

To adapt these notions to events from an event dataset, there is a question about how to compute the conditional probabilities p(y|x) and p(x|y) since there are potentially multiple occurrences of y and x that are staggered over T The present invention may take a window-based view of co-occurrence, making the assumption that causal influence is prevalent only for a limited time after an event occurs. For time window w, the present invention may compute two conditional probabilities:

$${p}^{w} ( y \vert x ) = \frac{{p}^{w} ( y ← x )}{p ( x )} ; {p}^{w} ( x \vert y ) = \frac{{p}^{w} ( x \to y )}{p ( y )} , \qquad ( 2 )$$

where p(y) and p(x) are the probabilities of observing events y and x respectively, i.e. p(y)=N(y)/T and p(x)=N(x)/T for event counts N(y) and N(x) over the horizon T.

The term p^{w}(y←x) is the probability (per time period) of observing cause y in a feasible window of length w time units before effect x. This term is computed from the event dataset by counting occurrences where x occurs and at least one y event occurs within the preceding time window (between times 0 and T), p^{w}(y←x)=N^{w}(y←x)/T.

The forward looking p(y→x) is computed by counting the number of occurrences where y occurs and at least one x event occurs within a feasible forward time window of length w, p^{w}(y→x)=N^{w}(y→x)/T. Every pair (y,x) is associated with a support:

s^{w}(y,x)=min{N^{w}(y←x), N^{w}(e→x)}. (3)

The present invention may apply the two conditional probabilities to propose novel adaptations of cause-effect scores from causal discovery from text. One related art method has presented a recent score which can be referred to as the necessity sufficiency trade-off (NST_{E}) score (the subscript signifies adaptation to an event dataset). NST_{E} requires a trade-off parameter λ∈[0,1] and a base rate penalization parameter α≥0. First, necessity and sufficiency scores are computed as follows:

$${CS}_{N} ( y , x ) = \frac{{p}^{w} ( y ← x )}{{p ( y )}^{α} p ( x )} ; {CS}_{S} ( y , x ) = \frac{{p}^{w} ( y \to x )}{p ( y ) {p ( x )}^{α}} . \qquad ( 4 )$$

The overall causal score combines these:

NST_{E}(y,x)=CS_{N}(y,x)^{λ}CS_{S}(y,x)^{(1-λ)}. (5)

Note that both the necessity and sufficiency scores involve a penalization term in the denominator using the parameter α which prevents frequent events from being considered as highly causally associative merely on the basis of chance. Higher values result in more penalization for frequent events.

It should be noted here that NST_{E} follows the General Framework by assuming: 1) p(x|y,Z)≈p(x|y) and p(x|Z)=p(x), 2) p(x|y) can be decomposed into backward y←x and forward y→x components, and 3)

$$\frac{{p}^{w} ( y ← x )}{{p ( y )}^{α}}$$

can approximate the backward y←x component of p(x|y) and similarly

$$\frac{{p}^{w} ( y \to x )}{p ( y )}$$

for the forward component. In addition, the test statistic is the ratio product between each component of p(x|y) and p(x).

A related causal score is the event control dependency (ECD_{E}) score which maximizes over two terms that are essentially proxies for necessity and sufficiency causality, ECD_{E}(y,x)=max{T_{N}, T_{S}}, where:

$${T}_{N} = [ \frac{{p}^{w} ( y ← x )}{p ( x ) - {p}^{w} ( y ← x ) + γ} ] \cdot [ \frac{{p}^{w} ( y ← x )}{{max}_{z} {p}^{w} ( y ← x ) - {p}^{w} ( y ← x ) + γ} ] , \qquad ( 6 )$$

and sufficiency term T_{S} is similar, with arrows in the other direction and p(y) replacing p(x) in the first term. The term γ≥0 is an error avoidance parameter to prevent a zero denominator and can be set to a low number (such as 0.01). T_{N} is a product of an adjusted odds term for y|x and a term that attempts to capture the importance of the effect x as compared to all other potential effects z.

It should be noted that the ECD_{E} score follows the General Framework by assuming: 1)

$$p ( x \vert y , Z ) \approx \frac{p ( x , y )}{p ( x , Z )} , 2 ) p ( x , y )$$

can be approximated by backward y←x and forward y→x components, 3) p^{w}(y←x) can approximate the backward y←x component of p(x|y) and similarly

$$\frac{{p}^{w} ( y \to x )}{p ( y )}$$

for the forward component, 4)

$$p ( x , v ) \approx [ {max}_{z ∈ Z} \frac{{p}^{w} ( y ← x )}{{p}^{w} ( y ← x )} - 1 ] .$$

The test statistic is the maximal ratio of each component of p(x,y) and the difference between p(x) and the said component.

The ECD_{E} score is different from NST_{E} in that it also considers all other potential effects of cause y. It also uses normalization twice in computing ratios.

It should also be noted that the above scores suffer from many shortcomings. The definitions of the terms p(x) and p(y) in these scores are interpretable as probabilities only in the special case where we have a finite set of time periods, and further, where there is at most one event occurrence per event label in each time period. In the setting where events may appear asynchronously and irregularly on the timeline, these definitions are not probabilities in general. Instead, they are gross (average) arrival rates for the event label under question, assessed over the time horizon.

While probability is a dimensionless quantity, these gross arrival rates have dimensions of count per unit time and are therefore sensitive to the units in which time is measured. This renders the above extension ad-hoc in general, even though it could be useful in practice.

This provides motivation to investigate the development of scores that are applicable in a continuous-time setting, devoid of arbitrarily chosen parameters and principled in their mathematical development. As described below, the present invention may develop a set of scores that build on the foundation of point processes.

Event datasets can be modeled as marked point processes using conditional intensity functions λₓ(t|h)>0 that represent the rate at which events of type x occur at time t given the history h. Since the present invention is concerned with association between a pair (y,x), it may begin by making a simplifying assumption: suppose that the intensity of x at any time only depends on whether at least one event of type y has occurred in the preceding window w. Furthermore, for now, suppose that the rate at which x occurs does not depend on any other event label besides y. This entails that x has only two intensity parameters, which is denoted λ_{x|y}^{w} and its complement λ_{x|y̅}^{w}.

Making no other assumptions about the history dependent intensities of other event types (including y), it can be shown that the maximum likelihood estimates for both parameters for x can be computed using summary statistics:

$${λ}_{x \vert y}^{w} = \frac{{N}^{w} ( y ← x )}{{D}^{w} ( y )} ; {λ}_{x \vert \overline{y}}^{w} = \frac{N ( x ) - {N}^{w} ( y ← x )}{T - {D}^{w} ( y )} , \qquad ( 7 )$$

where count N^{w}(y←x) is as defined in the previous section and duration

$${D}^{w} ( y ) = {Σ}_{i}^{N + 1} {\int }_{{t}_{x - 1}}^{{t}_{x}} {I}_{y}^{w} ( t ) d τ .$$

I_{y}^{w}(t) is an indicator for whether y has occurred at least once in the feasible window w preceding time t.

The present invention may introduce causal association scores that reflect how the conditional intensity of effect x is modified by the presence or absence of potential cause y. Specifically, the present invention proposes the following two conditional intensity ratios:

$${CIR}_{C} ( y , x ) = \frac{{λ}_{x \vert y}^{w}}{{λ}_{x \vert \overline{y}}^{w}} ; {CIR}_{B} ( y , x ) = \frac{{λ}_{x \vert y}^{w}}{{λ}_{x}} , \qquad ( 8 )$$

where the former uses the complement (C) as a reference versus the latter which considers the base rate (B) λₓ=N(x)/T.

It should be noted that CIR_{B} and CIR_{C} follow the General Framework by assuming: 1) p(x|y,Z)=p^{dτ}(x|y),p(x|Z)=p^{dτ}(x), and 2) p^{dτ}(x|y)=λ_{x|y}dτ,p^{dτ}(x)=λₓdτ. The test statistic for CIR_{B} is the ratio of p(x|y,Z) and p(x|Z), whereas that of CIR_{C} is the ratio of p(x|y,Z) and p(x|y̅,Z).

Both these CIR scores make several assumptions. The primary assumption that an effect x only depends on the history of potential cause y is likely unrealistic in real-world datasets. A more general formulation allows x to depend on the historical occurrences of any other event label. In the literature on graphical event models, this is captured by a (potentially cyclic) graphical representation where the rate at which x occurs at any time depends only on the historical occurrences of its parents in the graph.

For pair (y,x), suppose that x not only has y as a parent but also the set of event labels Z. If the rate at which x occurs depends on whether any of its parents y∪Z have occurred in the preceding window w, then there are 2^{|Z+1|} conditional intensity rates, the maximum likelihood estimates of which can be determined through summary statistics, similar to equation 7:

$${λ}_{x \vert y , z}^{w} = \frac{{N}^{w} ( y , z ← x )}{{D}^{w} ( y , z )} ; {λ}_{x \vert \overline{y} , z}^{w} = \frac{{N}^{w} ( y , z ← x )}{{D}^{w} ( \overline{y} , z )} , \qquad ( 9 )$$

where the counts and durations are generalizations of the previous definitions and can be computed similarly. FIG. 3 above illustrates how the timeline partitions various conditions for labels y and z, assuming window w=7 days. In this example, D( y,z)=D(y,z )=D( y,z )=8 days each and D(y,z)=6 days. The maximum likelihood estimate for rate

$${λ}_{x \vert y , z}^{w} = {N}^{w} ( y , z ← x ) \text{/} {D}^{w} ( y , z ) = \frac{1}{8} .$$

Since the present invention is interested in the pairwise association for (y,x), it is suggested here to gauge this using the aggregate impact of y on x over all possible conditions of the other parental influences z. Formally,

$${CIR}_{M} ( y , x ) = g ( \frac{{λ}_{x \vert y , z}^{w}}{{λ}_{x \vert \overline{y} , z}^{w}} ) , \qquad ( 10 )$$

where the subscript M denotes that x could have multiple influences and g(·) is an aggregation of ratios over all possible z.

The present invention considers three aggregation functions: average, minimum and maximum. The average measure, for instance, captures the average effect of how much y amplifies (or dampens) the rate of x, given the other relevant conditions. This score can therefore be viewed as a generalization of the CIR_{C} score. Support for all CIR scores is assumed to be s^{w}(y,x)=N^{w}(y←x).

It should be noted here that CIR_{M} follows the General Framework by assuming: 1) p(x|y,Z)=p^{dτ}(x|y,Z), p(x|Z)=p^{dτ}(x|Z), 2) p^{dτ}(x|y,Z)=λ_{x|y,Z}dτ, p^{dτ}(x|V)=λ_{x|Z}dτ. Moreover, the test statistic for CIR_{M} is some aggregated ratio of p(x|y,Z) and p(x|Z).

In order to compute Z, the present invention may follow a structure search like in other work on graphical event models. For this particular event model, the log likelihood of the dataset for event label x with parents U is:

$$LL ( x ) = {\sum }_{u} [ - {D}^{w} ( u ) {λ}_{x \vert u}^{w} + {N}^{w} ( u ← x ) log ( {λ}_{x \vert u}^{w} ) ] . \qquad ( 11 )$$

In the inventors' experiments, they first learned the parents of x that maximize the BIC score by searching for any additional parents Z (other than y) through a forward-backward search—a standard approach in structure learning in graphical models—and then computing the CIR_{M} score using the relevant summary statistics computed on the (optimal) learned graph (see equation 9). The BIC score is the sum of the log likelihood and a penalty term that incorporates the complexity of the model, which in this case equals 2^{|Z+1|} log(T). It is known to be asymptotically consistent for graphical event models. This approach is polynomial in the number of event labels |L| and linear in the size of the event dataset N, because the summary statistics required for computing the intensity parameters can be obtained in a single pass through the event dataset, for all event pairs.

Large political event datasets have been designed and deployed by political scientists for decades. The two largest ones—the Global Database of Events, Language and Tone (GDELT) and the Integrated Crisis Early Warning System (ICEWS)—are mined from news articles in multiple languages. Events in these datasets are of the form Actor1→Action→Actor2, i.e., “who does what to whom”, along with when (time) and where (location), plus a host of other meta-data.

Actors and actions in both ICEWS and GDELT are coded according to the Conflict and Mediation Event Observations (CAMEO) ontology, which includes a large number of domestic and international actor types. Actions in the CAMEO framework are hierarchically organized into 20 high-level and 310 low-level actions along two dimensions: whether they are verbal or material, and whether they involve cooperation or conflict. These datasets have been used by the statistics, artificial intelligence and machine learning communities. For instance, some have used a latent tensor Bayesian Poisson model to capture multilateral relations among different events and others have used a deep learning based framework to predict relational events.

In the inventors' experiments, they used a subset of ICEWS, focusing on 4 countries: Argentina, Brazil, Mexico and Venezuela in the time period Jan. 1, 2006 to Dec. 31, 2015. The inventors restricted their attention to the most frequent and interesting actors: Police, Citizen, Government, Head of Government, Protester and Military. Combining these yields a set of 24 distinct actors such as ‘Police (Brazil)’ and ‘Citizen (Mexico).’ The inventors augmented these 24 actors with 12 additional actors due to the high frequency of interaction with the base set of 24; they include ‘Armed Gang (Mexico)’ and ‘Guerrilla (Revolutionary Armed Forces of Colombia)’. The filtering process left the inventors with ˜25K event records spanning ˜2K distinct event types coded at the CAMEO base code level.

Statistical co-occurrence of events could potentially be effective for causal discovery when used in conjunction with knowledge from other sources. In computational linguistics, such knowledge can be obtained through discourse cues. While a relational event dataset cannot provide such cues, it does include information about the actors involved in events. The inventors believe that imposing additional conditions based on actor identities could enforce causal knowledge and thereby potentially match human assessments of causality.

One such condition is referred to as the common actor condition: event pairs with a common actor are more amenable to be assessed by humans as causal. This notion has been explored in other contexts, for instance, where it was recognized that “narrative chains are partially ordered sets of events centered around a common protagonist.” Requiring a common actor between events models causal reactions such as retaliation, reciprocity and reinforcement.

The inventors also considered the foreign actor condition: a foreign actor cannot influence an event between domestic actors. In other words, if an event involves interaction between actors belonging to the country in which the event occurs, its cause or effect should not involve another country. There are, of course, reasonable exceptions to either one of these conditions. For example, a foreign agent attacking a country could cause the government to provide aid to its citizens. Regardless, the inventors investigated whether applying these restrictions helps match human assessments.

To obtain baseline causal relationships in their dataset, the inventors designed surveys with 100 questions each for the 4 Latin American countries. The pairs selected for the surveys were sampled from the ranked NST_{E} scores with parameters α=1, λ=0.5, window w=15 and support s=10. To construct the surveys, the inventors drew 25 pairs, uniformly at random, from each quartile of the ranked scores for each country. They did this to ensure the presence of some pairs that are suspected to be causal and some that are not.

The surveys were provided to six project members, with each participant independently completing a survey for two out of the four countries, resulting in three raters for each question. Participants were asked whether the question involved a plausible causal pair of events (yes/no) and to also specify how confident they were about their answer (0-100%). All three raters were unanimous in their decision for a majority of the questions (225/400 questions).

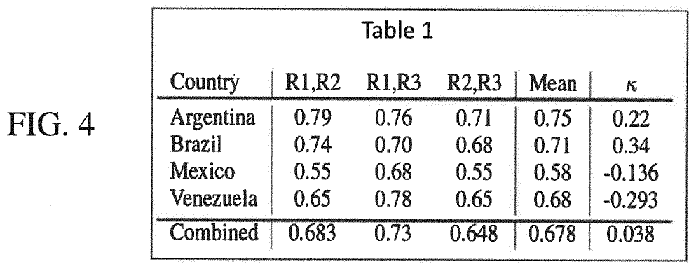

FIG. 4 illustrates Table 1 which shows the pairwise inter-rater probabilities, the mean over rater pairs and Fleiss' κ, according to an exemplary aspect of the present invention. In particular, Table 1 illustrates a pairwise inter-rater agreement along with the mean and Fleiss' κ for survey responses. There is reasonable agreement for Argentina and Brazil but less so for Mexico and Venezuela.

A pairwise agreement of 0.5 reflects a pair of raters who agree on half of the pairs, which is what one would expect to observe by chance. It can be seen that there is good agreement between the raters for Argentina and Brazil. Fleiss' κ is often used to measure interrater agreement. Informally, this measures the amount of agreement, beyond chance, based on the number of raters, objects and classes. Aκ>0.2 is typically taken to mean fair agreement between raters, although this rule-of thumb depends on the context and can be misleading.

The inventors' inter-rater agreement numbers are on par with results obtained from surveys in causality extraction from text. In these works, annotators are asked to identify if two sentences are causally related, e.g. global warming worsens→sea temperatures to rise.

Some have obtained an inter-rater agreement of 0.58 on this causal annotation task, which they use as their gold standard set in evaluation. Some have extracted pairs of text fragments proposed to be causal and then verified these using crowdsourced workers. They obtained a Fleiss κ of 0.67.

Note that the inventors consider a more challenging task here—identifying the relationship between atomic events rather than causality between text fragments in a paragraph, thereby providing less contextual information to the annotator. These textual datasets are not adaptable to event datasets as any given causal pair is unique and must be understood from the text.

The inventors considered two tasks that use the causal association scores of the present invention to predict human assessments and conduct 5-fold stratified cross validation to split the data into training and test folds, and measure the mean and standard deviation of the accuracy. The inventors searched over a range of hyper-parameters for the five models: α∈{0,0.5,1,2,5}, λ∈{0,0.25,0.5,0.75,1} for NST_{E}, γ∈{0.001,0.005,0.01,0.05,0.1} for ECD_{E}, g={avg,max,min} for CIR_{M} and window w={7,15,30} days for all models, using support s=10.

The inventors' first task was to examine how well their scores/models can predict the human binary responses. They treated the majority vote of the yes/no responses as ground truth and used a simple one-dimensional threshold classifier on the causal scores to predict whether a pair is causal. Since the four causal scores may have different ranges for different countries, the inventors normalized within a country by converting to z scores (i.e., the inventors subtracted the mean from the score and divided by the standard deviation.

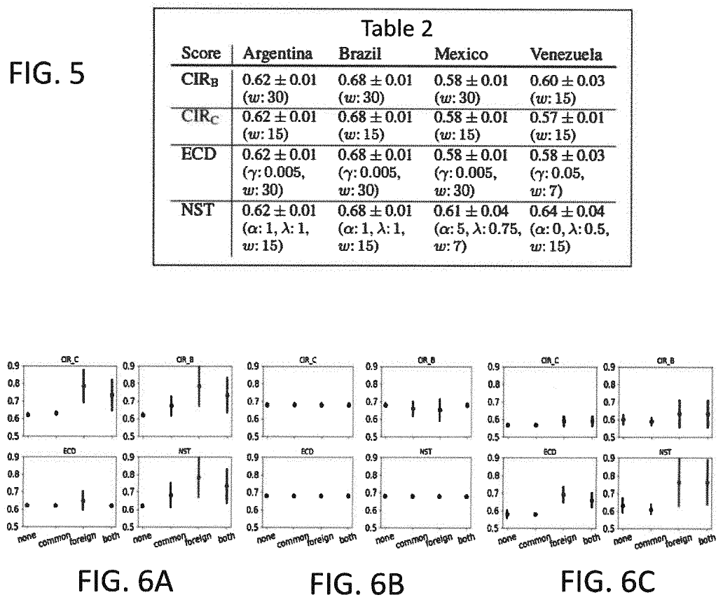

FIG. 5 illustrates Table 2 which shows the accuracy over folds (mean±standard deviation) corresponding to the best hyper-parameter configuration for each model and country, for the majority vote task, according to an exemplary aspect of the present invention.

As presented in Table 2, for Brazil, the models are indistinguishable. They are, in fact, unable to sufficiently distinguish the human-assessed labels. Among the models, CIR_{M} performs best for Argentina and NST_{E} performs best for Mexico and Venezuela. For Venezuela, the best NST_{E} model balances necessity and sufficiency causality (λ=0.5) and does not require penalization for frequent events (α=0). The inventors performed additional sensitivity analysis and learned that results did not vary significantly with changes to window w and support s.

As the general majority vote task is difficult, the inventors turned to measuring the effect of enforcing the actor-based conditions by setting the causal score for a survey pair that violates the particular condition to zero (before z-scoring).

FIGS. 6A-6C illustrate the accuracy across the folds for the majority vote task by application of conditions none, common actor, foreign actor, or both for three countries. In particular, FIG. 6A illustrates the accuracy across the folds for the majority vote task for Argentina. FIG. 6B illustrates the accuracy across the folds for the majority vote task for Brazil. FIG. 6C illustrates the accuracy across the folds for the majority vote task for Venezuela.

The plots in FIGS. 6A-6C compare the accuracy across the folds for the three countries while enforcing none, one or both of the two conditions. As illustrated in FIGS. 6A-6C, imposing the conditions, particularly the foreign actor condition, improves performance in several cases. For Argentina, all scores improve substantially over those seen in Table 2.

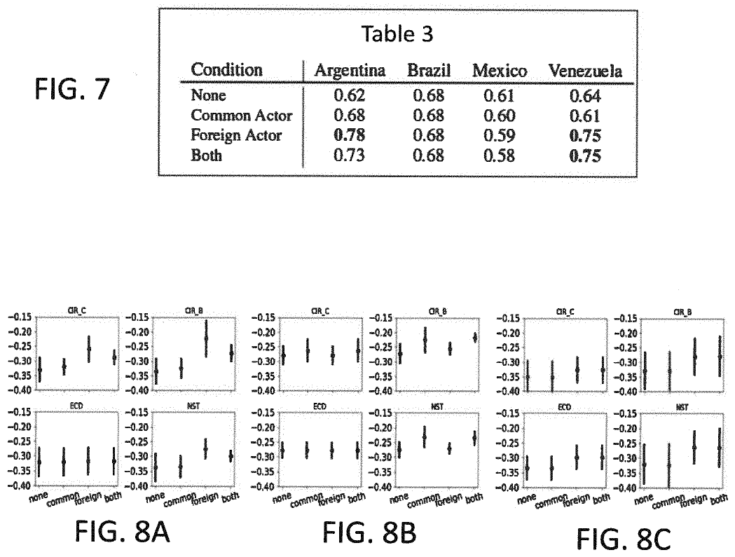

FIG. 7 illustrates Table 3 which presents best mean accuracy (over folds) for the majority vote task as a function of the actor-based conditions, according to an exemplary aspect of the present invention. That is, Table 3 shows the best performance for each country across all possible models. Adding the foreign actor condition increases the best mean accuracies for Argentina and Venezuela from 63% to 76% and 62% to 76% respectively.

In their second task, the inventors included human assessments about their confidence and aggregated them into a numeric confidence strength, which they predict using a linear regression model on the proposed cause-effect scores (after z-scoring). This strength is measured on a scale of −1 (strong no) to 1 (strong yes) and obtained by applying a positive (negative) sign for the binary response yes (no) and averaging over raters' confidences.

For example, if three raters' responses with confidences are {(no,70%),(no,40%), (yes, 50%)}, then the confidence strength is (−0.7−0.4+0.5)/3=−0.2. The inventors chose negative root mean squared error as the evaluation metric, ensuring that a higher metric is better. As there are 20 questions that are tested in every fold, the potential range for this metric is 0 (best) to −2 √20 ≈−9(worst), which occurs if for all questions in all folds, a strength of −1 (strong no) is predicted to be 1 (strong yes) or vice-versa.

FIGS. 8A-8C illustrate the accuracy applying the similar conditions as in FIGS. 6A-6C, but using evaluation metric as negative root mean squared error for the confidence strength task. In particular, FIG. 8A illustrates the accuracy for the confidence strength task for Argentina. FIG. 8B illustrates the accuracy for the confidence strength task for Brazil. FIG. 8C illustrates the accuracy across for the confidence strength task for Venezuela.

That is, FIGS. 8A-8C compare this metric across the folds for three countries, separated by the actor conditions. CIR_{B} generally performs better on this task than other models. It can be observed again that imposing the conditions improves performance in many cases although it is less pronounced here. Note that the ≈0.1 improvement of CIR_{B} in Argentina from enforcing the foreign actor condition corresponds to an improvement of ≈0.022 in the inventors' prediction of confidence strength per question. Overall, the small mean errors observed in this task (relative to the scale) indicate that the scores are better at predicting the numeric confidence strength than they are at predicting binary labels.

The inventors also conducted a qualitative assessment to better understand the reasons for disagreement. They ran the CIR_{B} score (w=15 with the foreign actor condition) on all 100 pairs for Argentina, comparing the predicted labels with majority vote responses. Examining the false positives, the inventors found that most are due to imposing the foreign actor condition. An example that was deemed to be causal by humans is Government (Argentina) Express Intent To Cooperate Government (Bolivia)→Citizen (Argentina) Disapprove Government (Argentina). Therefore, although the net effect of adding the condition is to improve accuracy, it does come at the cost of precision.

The false negative results are even more interesting. Most involve a drastic change across events with a rapid escalation or turn-around of an action. Examples include the pairs Citizen (Argentina) Express Intent To Cooperate Government (Argentina)→Police (Argentina) Assault Citizen (Argentina) and Police (Argentina) Provide Aid Citizen (Argentina)→Police (Argentina) Coerce Citizen (Argentina). These results beg the question, are the scores incorrect or are humans incorrect in their perception of such reversals? If the former is true then perhaps applying action-based conditions in addition could be fruitful for relational events. In either case, such an insight could be beneficial for analysts, shedding light on relationships that the analysts may not have considered.

Described below is a manner in which the present invention may orchestrate narratives (event sequences) (e.g., generate event sequences using the sequence generator 220) and display narratives to an analyst. As described below, the present invention may leverage other modules to provide multi-modal interactions for the evaluation and display of narratives.

Candidate narratives that are required could come from any number of sources, such as another system which automatically generates candidate narratives, or a database of pre-computed or pre-constructed narratives, or by the analyst who builds a narrative list real-time by selecting potential sequences of events from the set of possible event tokens. The inventors have implemented different approaches to generating candidate narratives that are displayed interactively.

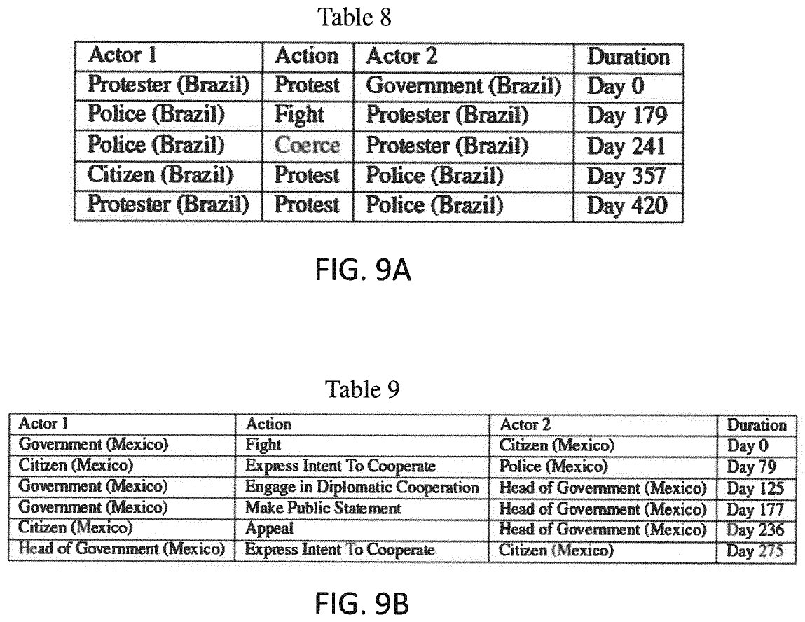

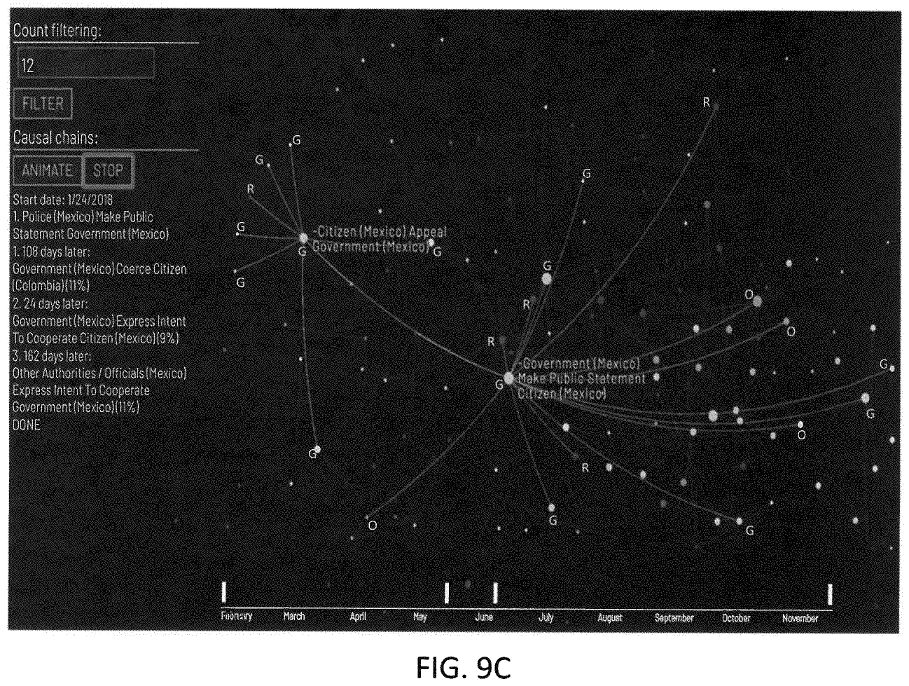

FIG. 9A illustrates Table 8 which presents a causal association based sequence with duration in Brazil. FIG. 9B illustrates Table 9 which presents a causal association based sequence of six events and their duration in Mexico.

In Tables 8 and 9 the inventors have extracted example narratives from the causal association scores computed by the present invention (e.g., computed by the score discoverer 210). To generate these narratives, the present invention (e.g., sequence generator 220) follows a simple random algorithm which uses the computed causal association scores as a weighting on the edges over which the algorithm will walk. Hence, even for the same start point, during the discovery phase, an analyst may be taken down a different path, hopefully augmenting his creativity.

To build a narrative, the sequence generator 220 may start by randomly selecting a node in the graph defined by having the set of events as nodes and directed, weighted edges between nodes corresponding to the computed scores. Since the present invention may have already pre-processed the results of the score discoverer 210 to remove nodes with low support and low association scores, it is reasonable to assume that nodes left on this graph (1) happen relatively frequently and (2) are causally related.

Hence, the sequence generator 220 can generate an event sequence by, at each step, hopping to a node that has a high causal relationship to the currently located node, and taking this transition with probability proportional to the causal association score. The sequence generator 220 may then augment this information with duration predictions from a plausibility module to create a rich, plausible narrative that could be inspiring to the analyst.

An example of visually representing the event sequences generated by the sequence generator 220 is depicted in FIG. 9C which is described in more detail below.

The causal association scores for event pairs have a number of potential applications. In general, they could help analysts in various domains understand relationships between events and stories that arise from a sequence of events. Manipulating and visualizing these relationships may help analysts understand the data better and think more creatively about possible future sequences of events.

The inventors have built an interactive visualization tool that enable analysts to explore causal associations between events and experiment with possible event sequences (generated by the sequence generator 220) in a country over a future timeline.

FIG. 9C illustrates an exemplary embodiment of an interactive visualization tool 900 (e.g., a screenshot of a tool), according to an exemplary aspect of the present invention. The tool 900 allows a user to explore, interactively, a cause-effect association graph, animate likely narratives on this graph by automatically moving between nodes, and get an updated timeline with even durations predicted by the inter-events research. In short, the tool 900 allows the analyst to explore the space of narratives.

As illustrated in FIG. 9C, the tool 900 provides a network visualization of causal event pairs (e.g., in Mexico). The layout of the visualization is initialized with PivotMDS and refined using stress majorization.

The nodes (e.g., circles) in FIG. 9C represent events while event pairs are represented by using directed edges. The nodes are sized by degree and colored on a scale from green to red, with red representing events of conflict while green is for events of co-operation, in accordance with the CAMEO hierarchy. That is, the nodes may be colored in shades from green (most cooperative) to orange, to red (most conflicting) according to the action in the CAMEO code. In FIG. 9C, the green, orange and red nodes are labeled G, O and R, respectively.

The size of the nodes may be used to represent the degree of the node, and edge thickness (e.g., weight) may be used to represent causal association score for a pair of events. Events are shown in the sidebar on the left side of the tool 900 as well as on a dynamic timeline with an estimate of expected time of occurrence.

In order to provide additional clarity, a user may specify a support threshold. Increasing this number results in filtering out causal scores with less statistical basis in the subsequent visualization.

The inventors also enabled a dynamic animation system that simulates causal event chains on a timeline. An analyst (e.g., user) may select a node of interest and the system hops to a new event based on the distribution of the causal scores. This may continue to cycle through the event network until the user terminates the process or a node without outgoing edges is reached.

Each edge is also associated with an approximate time estimate, based on stochastic event models. These are displayed on a running timeline starting from the initially chosen event. All encountered events are listed in the sidebar and in the timeline, allowing analysts to investigate potential future event sequences.

Knowledge workers in many domains including intelligence, business, and finance are often expected to provide thoughtful and reasoned analysis about current and future states of the world based on both numerous data sources and their expert opinions. Of particular interest are relational (dyadic) events, i.e., events of the form Actor1->Action->Actor 2. Here Actor1 performs some Action to Actor2 and this event is typically associated with other information including location, intensity, etc.

It is often important to understand the relationships between events and examine potential future consequences of initiating events. Discovering, visualizing, and working with causal relationships from observational data is widely studied in AI and other domains. A system that can discover and visualize cause-effect associations between pairs of events could help an analyst imagine future worlds.

The present invention addresses the problem of discovering and visualizing the cause-effect relationship between events and may include, for example, the following steps.

1. Inputting a set of historical events consisting of one or more event labels/tokens along with (optionally) a set of additional parameters of interest including start and end dates, support thresholds, cause-effect windows, and countries/locations.

2. Using any of a number of algorithms described in the paper, discover causal association scores for all pairs of events that meet the specified requirements.

3. For these pairs of events, (optionally) obtaining inter-event time estimates from related models.

4. Outputting the results of the analysis in an interactive graph front end which shows the cause-effect relationships between events as well as the intensity of this relationship.

5. Enabling interactive analysis where the user can study the graph and conduct local discovery (around an event), and/or request the system to generate possible future narratives that are animated, using the causal association scores and (optionally) the inter-event time estimates for analyzing durations.

The present invention differs from the state-of-the-art in at least the following ways:

1. The present invention may use structured event datasets as input, which may or may not be created from unstructured sources such as news or blogs/Twitter.

2. The present invention may focus on explicit quantitative measures of the cause-effect relationship that are grounded in well-reasoned analytical techniques and rigorous definitions.

3. The present invention can combine the causal association scores with other attributes and display them in an interactive environment which will spark analyst creativity and stand up to rigorous model investigation and quantitative assessment.

4. The present invention a) is highly interactive, and b) enables the use of multiple attributes of narratives (minimally, duration and causal association) which provides flexibility for the analyst to discover interesting future event sequences.

More particularly, a main idea of the present invention is based on the use of an event dataset which include may include, for example, multivariate/marked asynchronous event stream data, where each event has a time-stamp and a complex object that serves as a “mark”. A “mark”, may be defined, for example, as a type of event related detail. For example, a relational (also known as “dyadic”) event includes information like (Actor 1<Action>Actor 2) that may also be hierarchically organized and may include a location of the event.

In short, an exemplary aspect of the present invention may include the following core ideas:

1. Use mathematical models for quantifying pair-wise cause-effect association, by proposing novel pair-wise scores that assume a conditional piece-wise constant intensity model for the successor, conditional on the present/absent state of the predecessor in a specified time window into the relative past.

This is the first time that such an approach has been used to quantify cause-effect association. This idea is possible due to the fact that the input data is an event dataset.

2. Extend and adapt necessity and sufficiency based scores to work with event stream data, to provide yet another way of quantifying pair-wise cause-effect association.

Existing methods assess causal association scores between words, but the invention provides non-trivial extension and adaptation to event stream data.

3. Use the above pair-wise cause-effect scores to generate sequences of events across multiple event types.

4. Use mathematical models to estimate inter-event expected duration of time between any two consecutive events for any two event types, and use such models to derive a time-stamped version of the above plausible event sequence.

5. Derive a graph-based visualization of event narratives (sequence of events) by mapping it to a time-stamped walk in a digraph whose nodes are event types, directed edges are cause-effect relationships from predecessor to successor, the weight of the edge is the corresponding causal association score computed using models in (1) and (2), and the time-stamps on the nodes are based on the inter-event duration computed from models in (4).

The visualization of the present invention is novel in that it can display the qualitative pair-wise associations and also display information (including quantitative information) about event sequences, such as estimates of event occurrence times. Again, this is possible mainly due to the fact that the input data is an event dataset.

6. For relational events, use information about actors and actions to provide additional conditions that can improve causal association scores computed using models mentioned in (1) and (2).

This is the first time that information about actors and actions in relational events has been used for discovering pair-wise cause-effect association. This is possible due to the additional information that is available in relational event datasets, which involve interaction between actors.

In particular, the present invention is directed to a method and system that assists human analysts who analyze future event dynamics in any domain, by: discovering a pair-wise predecessor (cause)-successor (effect) score for any pair of event types from event datasets comprising multiple event types, and generating causal sequences of potential future inter-dependent event types that may unfold in time, using the afore-mentioned scores, along with an estimate of their respective occurrence times

Specifically, an exemplary aspect of the present invention learns from multi-variate time-stamped event data, which may be labeled using a dyadic relational format involving “Actor1<Action>Actor2” triple, where each of “Actors” and “Actions” are hierarchically organized. The learning is done at an appropriate level of resolution across actor/action hierarchies for a) historical data sufficiency or b) generalization from finer to coarser event type description, by lifting the data analysis to a higher level in the hierarchy.

Further, an exemplary aspect of the present invention uses an inter-event duration mathematical model that learns the expected duration between any two consecutive occurrences involving any two event types from data, and uses the expected duration in estimating the time-stamps for events that make up any generated event sequence.

Further, the pair-wise causal association scores may be due to a pair-wise conditional intensity model that estimates the conditional instantaneous intensity (or arrival rate) of the successor event type from data, i.e., intensity that is conditional on both the presence as well as the absence of the predecessor event type in a specified historical time window, with the assumption of a piece-wise constant (Poisson) intensity for event arrival rate of the successor event type, with a different constant intensity corresponding to each predecessor state (absent/present in the specified time window)

As an alternative, the model for pair-wise causal association score may be due to a method that computes a necessity score by analyzing the presence or absence of the predecessor event type in a specified backward-looking (into the relative past) time window relative to each successor event type occurrence in the data, and a sufficiency score by analyzing the presence or absence of the successor event type in a specified forward-looking (into the relative future) time window relative to each predecessor event type occurrence in the data, and arrives at a causal association score that combines the necessity and sufficiency scores using a mathematical formula to reflect the both aspects of necessary and sufficient influences of predecessor event types on successor event types.

The exemplary aspect of the present invention may also provides advisory help and assistance to human analysts who analyze future inter-dependent multi-variate event streams, by deriving a graph-based visualization that uses the pair-wise causal association scores and optionally the expected inter-event duration, and displays the causal association scores.

Additionally, the graph based visualization displays multiple event narratives (where a narrative is a sequence of events across event types), where each narrative is shown as a time-stamped walk in a digraph whose nodes are event types, directed edges are cause-effect relationship from predecessor to successor, the weight of the edge is the corresponding causal association score, and the time-stamps on the nodes are based on the inter-event duration.

The graph-based visualization also considers additional criteria for each edge in the graph, such as the number of data-points using which the corresponding cause-effect score was computed, as an additional quality-proxy for the edge, i.e. more support in terms of data points in the history is taken to be a proxy for higher quality.

Further, the present invention may use additional information about actors and actions in relational events to frame the analysis or improve the causal association scores. This information could specify the resolution or scope, such as type of actors/actions (resolution in data) or location/time-frame (scope in data).

### Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Instead, the embodiments of the present invention are capable of being implemented in conjunction with any other type of computing environment (e.g., distributed computing environment) now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

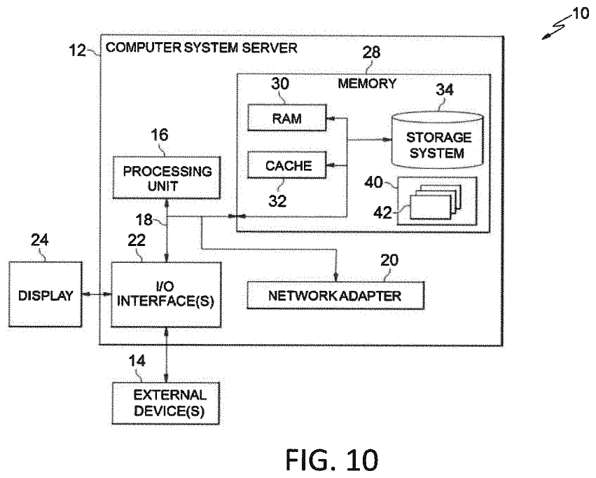

Referring now to FIG. 10, a schematic of an example of system (e.g., system 200) which may serve as a cloud computing node in a cloud computing environment. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 10, a computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further described below, memory 28 may include a computer program product storing one or program modules 42 comprising computer readable instructions configured to carry out one or more features of the present invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may be adapted for implementation in a networking environment. In some embodiments, program modules 42 are adapted to generally carry out one or more functions and/or methodologies of the present invention.

Computer system/server 12 may also communicate with one or more external devices 14 such as a keyboard, a pointing circuit, other peripherals, such as display 24, etc., and one or more components that facilitate interaction with computer system/server 12. Such communication can occur via Input/Output (I/O) interface 22, and/or any circuits (e.g., network card, modem, etc.) that enable computer system/server 12 to communicate with one or more other computing circuits. For example, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

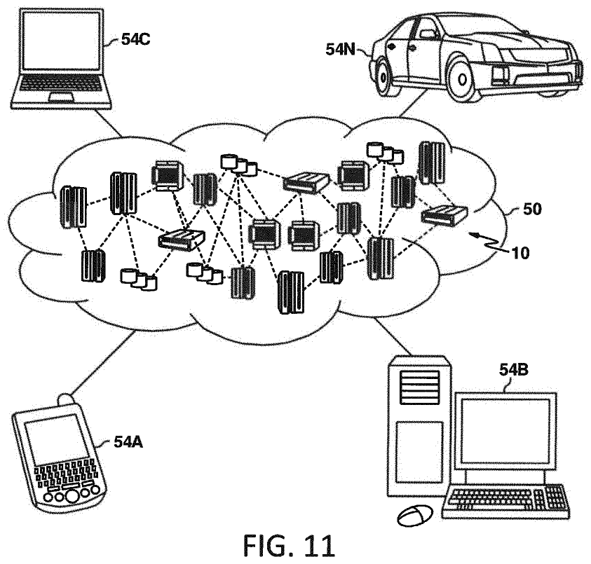

Referring now to FIG. 11, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 11 are intended to be illustrative only and that computing nodes 10 and cloud computing environment 50 can communicate with any type of computerized circuit over any type of network and/or network addressable connection (e.g., using a web browser).

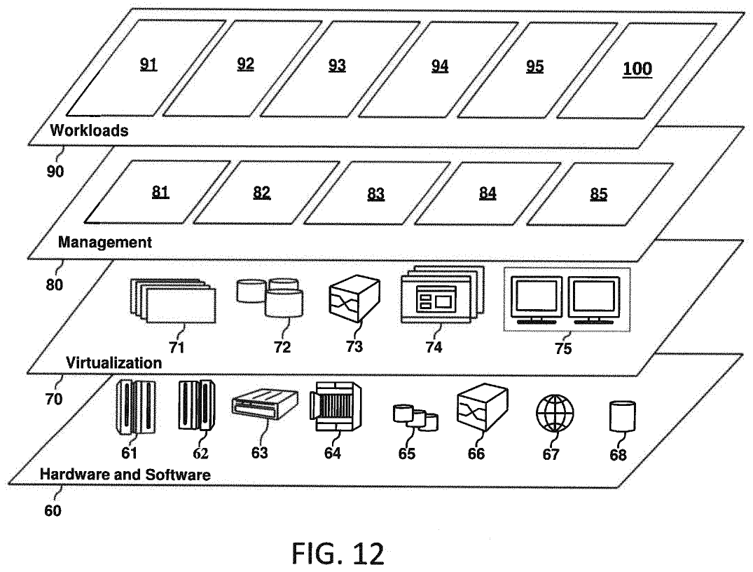

Referring now to FIG. 12, an exemplary set of functional abstraction layers provided by cloud computing environment 50 (FIG. 10) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and the method 100 in accordance with the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), a Storage Area Network (SAN), a Network Attached Storage (NAS) device, a Redundant Array of Independent Discs (RAID), an erasable programmable read-only memory (EPROM or Flash memory), a static random access memory (SRAM), a portable compact disc read-only memory (CD-ROM), a digital versatile disk (DVD), a memory stick, a USB “thumb” drive, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A method of discovering and presenting associations between events, comprising:
discovering causal association scores for pairs of events in an event dataset; and
generating a sequence of events based on the causal association scores.

2. The method of claim 1, further comprising:
generating a graph based on the causal association scores, the graph displaying the sequence of events on a timeline.

3. The method of claim 2, further comprising:
inputting an inter-event time estimate for the pairs of events from a related model.

4. The method of claim 3, wherein the graph enables interactive analysis by a user such that the user can study the graph and conduct local discovery around an event.

5. The method of claim 2, wherein the graph displays the generated sequence of events as an event narrative which is displayed as a time-stamped walk in a digraph having event types represented by nodes, a cause-effect relationship from predecessor to successor represented by a directed edge, a causal association score represented by a weight of the directed edge, and an inter-event duration represented by a time-stamp on the nodes.

6. The method of claim 1, wherein the event dataset comprises a plurality of events having a plurality of event types.

7. The method of claim 1, further comprising:
inputting parameters comprising at least one of a start date, an end date, a support threshold, a cause-effect window, and a location.

8. The method of claim 1, wherein the discovering of the causal association scores comprises discovering the causal association scores based on temporal co-occurrence.

9. The method of claim 8, wherein the discovering of the causal association scores based on temporal co-occurrence comprises:
computing a necessity score by analyzing a presence or absence of a predecessor event type in a backward-looking time window relative to a successor event type;
computing a sufficiency score by analyzing a presence or absence of a successor event type in a forward-looking time window relative to a predecessor event type; and
discovering the causal association scores based on the necessity and sufficiency scores.

10. The method of claim 1, wherein the discovering of the causal association scores comprises discovering the causal association scores based on conditional intensity.

11. The method of claim 10, wherein the discovering of the causal association scores based on conditional intensity comprises modeling the event dataset as a marked point process using a conditional intensity function λₑ(t|h)>0 that represents a rate at which an event of type e occurs at time t given a history h.

12. The method of claim 1, wherein the event dataset comprises multi-variate time-stamped event data, that is labeled using a dyadic relational format involving an Actor1<Action>Actor2 triple, where the Actors and Actions are organized in a hierarchy.

13. The method of claim 12, wherein the discovering of the causal association scores is performed at an appropriate level of resolution across actor/action hierarchies for one of historical data sufficiency and generalization from finer to coarser event type description, by lifting data analysis to a higher level in the hierarchy.

14. A computer program product for discovering a relationship between events, the computer program product comprising a computer-readable storage medium having program instructions embodied therewith, the program instructions executable by a computer to cause the computer to perform:
discovering causal association scores for pairs of events in an event dataset; and
generating a sequence of events based on the causal association scores.

15. A system for discovering a relationship between events, comprising:
a score discoverer for discovering causal association scores for pairs of events in an event dataset; and
a sequence generator for generating a sequence of events based on the causal association scores.

16. The system of claim 15, further comprising:
a graph generator which generates a graph based on the causal association scores, the graph displaying the sequence of events on a timeline.

17. The system of claim 15, further comprising:
an input device for inputting an inter-event time estimate for the pair of events from a related model.

18. The system of claim 17, wherein the graph enables interactive analysis by a user such that the user can study the graph and conduct local discovery around an event.

19. The system of claim 15, wherein the graph displays the generated sequence of events as an event narrative which is displayed as a time-stamped walk in a digraph having event types represented by nodes, a cause-effect relationship from predecessor to successor represented by a directed edge, a causal association score represented by a weight of the directed edge, and an inter-event duration represented by a time-stamp on the nodes.

20. The system of claim 15, further comprising:
a processor; and
a memory, the memory storing instructions to cause the processor to function as the score discoverer and the sequence generator.
